(19) United States
(12) Patent Application Publication
(10) Pub. No.: US 2013/0250466 A1
(43) Pub. Date: Sep. 26, 2013

(54) SHORT CIRCUIT APPARATUS AND METHOD

(71) Applicant: ENERDEL, INC., Greenfield, IN (US)

(72) Inventors: Tony L. Taylor, Martinsville, IN (US); Wendell Ferguson, Daleville, IN (US); David Garner, Indianapolis, IN (US); Jeffrey D. Villines, Greenwood, IN (US); Peter A. Moody, Carmel, IN (US)

(73) Assignee: ENERDEL, INC., Greenfield, IN (US)

(21) Appl. No.: 13/800,351

(22) Filed: Mar. 13, 2013

Related U.S. Application Data
(60) Provisional application No. 61/613,184, filed on Mar. 20, 2012.

(51) Int. Cl. H02H 3/08

(52) U.S. Cl. CPC H02H 3/08
USPC 361/93.9

(57) ABSTRACT

An assembly is disclosed which may include a serviceable unit and a current limiting device coupled to the serviceable unit. The serviceable unit may include a positive electrical terminal connection, a negative electrical terminal connection, and a plurality of energy storage devices operatively coupled to the positive electrical terminal connection and the negative electrical terminal connection to form an electrical path of the serviceable unit. The current limiting device may include a current limiting component. The current limiting component being included in the electrical path of the serviceable unit.

### RELATED APPLICATION

This application claims the benefit of U.S. Provisional Application Ser. No. 61/613,184, filed Mar. 20, 2012, titled SHORT CIRCUIT APPARATUS AND METHOD, docket ENERD-P12-001-01-US, the description of which is expressly incorporated by reference herein.

### FIELD

The disclosure relates in general to methods and systems for storing and providing energy with a serviceable unit and, more particularly, to methods and systems for storing and providing energy with an assembly including a serviceable unit and a current limiting device.

### BACKGROUND

Energy storage systems are known. Exemplary energy storage systems are disclosed in PCT Published Application No. WO2012/167269, application number PCT/US2012/040776, filed Jun. 4, 2012, titled ENERGY STORAGE SYSTEM and in PCT Published Application No. WO2012/158185, application number PCT/US2011/052169, filed Sep. 19, 2011, titled ENERGY STORAGE SYSTEM, the disclosures of which are expressly incorporated by reference herein.

### SUMMARY

In an exemplary embodiment of the present disclosure, an assembly is provided. The assembly including a serviceable unit and a current limiting device.

In another exemplary embodiment of the present disclosure, an assembly is provided. The assembly comprising a serviceable unit including a positive electrical terminal connection, a negative electrical terminal connection, and a plurality of energy storage devices operatively coupled to the positive electrical terminal connection and the negative electrical terminal connection to form an electrical path of the serviceable unit; and a current limiting device coupled to the serviceable unit and including a current limiting component. The current limiting component being included in the electrical path of the serviceable unit.

In an example of the another exemplary embodiment, the current limiting component is selected from the group of a resistor and a fuse.

In another example of the another exemplary embodiment, the current limiting device is removably coupled to one of the positive electrical terminal connection and the negative electrical terminal connection. In a variation thereof, the current limiting component is selected from the group of a resistor and a fuse. In another variation thereof, the plurality of energy storage devices includes a plurality of prismatic cells electrically coupled together, the plurality of electrical storage devices having a fully charged open circuit voltage of between about 12 volts and about 192 volts. In yet another variation thereof, the plurality of energy storage devices includes a plurality of prismatic cells electrically coupled together, the plurality of electrical storage devices having a fully charged open circuit voltage of between about 24 volts and about 48 volts. In a further variation thereof, the current limiting device is press fit onto one of the positive electrical terminal connection and the negative electrical terminal connection. In yet a further variation thereof, the current limiting device provides a terminal that is electrically connected to the one of the positive electrical terminal connection and the negative electrical terminal connection that the current limiting device is coupled to through the current limiting component. In a refinement of the yet a further variation, the current limiting device includes a terminal connector having a cavity which receives the one of the positive electrical terminal connection and the negative electrical terminal connection and a base which is coupled to the terminal connector and the current limiting component. In a further refinement thereof, the terminal is supported by the base.

In yet another example of the another exemplary embodiment, the current limiting device is coupled to the serviceable unit in place of an electrical component of the electrical path. In a variation thereof, the current limiting component is selected from the group of a resistor and a fuse. In another variation thereof, the plurality of energy storage devices includes a plurality of prismatic cells electrically coupled together, the plurality of electrical storage devices having a fully charged open circuit voltage of between about 12 volts and about 192 volts. In a further variation thereof, the plurality of energy storage devices includes a plurality of prismatic cells electrically coupled together, the plurality of electrical storage devices having a fully charged open circuit voltage of between about 24 volts and about 48 volts.

In still another example of the another embodiment, the current limiting device is positioned in a first configuration relative to the serviceable unit to place the current limiting component in the electrical path and in a second configuration relative to the serviceable unit to remove the current limiting component from the electrical path. In a variation thereof, the current limiting device includes a carrier which supports current limiting component, the carrier being moveable relative to a housing of the serviceable unit, the carrier being in a first position relative to the housing in the first configuration and in a second position relative to the housing in the second configuration. In another variation thereof, the current limiting component is selected from the group of a resistor and a fuse. In still another variation thereof, the plurality of energy storage devices includes a plurality of prismatic cells electrically coupled together, the plurality of electrical storage devices having a fully charged open circuit voltage of between about 12 volts and about 192 volts. In yet still another variation thereof, the plurality of energy storage devices includes a plurality of prismatic cells electrically coupled together, the plurality of electrical storage devices having a fully charged open circuit voltage of between about 24 volts and about 48 volts.

In a further exemplary embodiment of the present disclosure, a method of testing a serviceable unit is provided. The serviceable unit including a positive electrical terminal connection, a negative electrical terminal connection, and a plurality of energy storage devices operatively coupled to the positive electrical terminal connection and the negative electrical terminal connection to form an electrical path of the serviceable unit. The method comprising the steps of sequentially: (a) placing a current limiting device in the electrical path of the serviceable unit, the current limiting device including a current limiting component; (b) subjecting the serviceable unit with the current limiting device to a vibration testing; (c) measuring a voltage of the serviceable unit, the voltage generally corresponding to the voltage difference between the positive electrical terminal connection and the negative electrical terminal connection; (d) shorting the positive electrical terminal connection to the negative electrical terminal connection; and (e) removing the current limiting device from the electrical path of the serviceable unit.

In one example of the further exemplary embodiment, the step of placing the current limiting device in the electrical path of the serviceable unit includes the step of coupling the current limiting device to one of the positive terminal electrical connection and the negative terminal electrical connection, the current limiting device providing a terminal, the current limiting component being in an electrical path between the one of the positive terminal electrical connection and the negative terminal electrical connection and the terminal. In a variation thereof, the step of measuring a voltage of the serviceable unit, the voltage generally corresponding to the voltage difference between the positive electrical terminal connection and the negative electrical terminal connection is performed by measuring a voltage between the terminal of the current limiting device and the other of the positive electrical terminal connection and the negative electrical terminal connection. In another variation thereof, the step of shorting the positive electrical terminal connection to the negative electrical terminal connection includes the step of establishing an external electrical connection between the terminal of the current limiting device and the other of the positive electrical terminal connection and the negative electrical terminal connection. In a refinement of the another variation, the external electrical connection between the terminal of the current limiting device and the other of the positive electrical terminal connection and the negative electrical terminal connection includes a circuit resistance of less than 0.1 ohms. In still another variation, the method further comprises the steps of: maintaining the external electrical connection for at least one hour; and monitoring an external temperature of the serviceable unit. In still a further variation thereof, the step of coupling the current limiting device to one of the positive terminal electrical connection and the negative terminal electrical connection includes the step of receiving the one of the positive terminal electrical connection and the negative terminal electrical connection within a cavity of the current limiting device.

In another example of the further exemplary embodiment, the step of placing the current limiting device in the electrical path of the serviceable unit includes the step of replacing an electrical conductor of the serviceable unit with the current limiting device.

In another example of the further exemplary embodiment, the electrical conductor of the serviceable unit and the current limiting device are supported by a carrier and the step of replacing the electrical conductor of the serviceable unit with the current limiting device includes the step of rotating the carrier which removes the electrical conductor of the serviceable unit from the electrical path of the serviceable unit and includes the current limiting device in the electrical path of the serviceable unit.

In any of the preceding examples of the further exemplary embodiment, the method further includes at least one of the following steps that are performed in any order between step (a) and step (d): subjecting the serviceable unit with the current limiting device to an altitude testing; subjecting the serviceable unit with the current limiting device to a thermal cycling testing; and subjecting the serviceable unit with the current limiting device to a shock testing.

In any of the preceding examples of the further exemplary embodiment, the method further includes at least two of the following steps that are performed in any order between step (a) and step (d): subjecting the serviceable unit with the current limiting device to an altitude testing; subjecting the serviceable unit with the current limiting device to a thermal cycling testing; and subjecting the serviceable unit with the current limiting device to a shock testing.

In any of the preceding examples of the further exemplary embodiment, the method further includes at least all of the following steps that are performed in any order between step (a) and step (d): subjecting the serviceable unit with the current limiting device to an altitude testing; subjecting the serviceable unit with the current limiting device to a thermal cycling testing; and subjecting the serviceable unit with the current limiting device to a shock testing.

The above and other features of the present disclosure, which alone or in any combination may comprise patentable subject matter, will become apparent from the following description and the attached drawings.

### BRIEF DESCRIPTION OF THE DRAWINGS

The aspects and many of the attendant advantages of this invention will become more readily appreciated as the same become better understood by reference to the following detailed description when taken in conjunction with the accompanying drawings.

FIG. 1 illustrates an exemplary serviceable unit;

FIG. 1A illustrates a representative view of the exemplary serviceable unit of FIG. 1;

FIG. 2 illustrates an exemplary serviceable unit and an exemplary current limiting device adapted to be coupled to a terminal connection of the serviceable unit;

FIG. 2A illustrates a representative view of the exemplary serviceable unit and current limiting device of FIG. 2;

FIG. 3 illustrates an exemplary serviceable unit and an exemplary current limiting device adapted to be coupled in an electrical connection between two series battery units of the serviceable unit, the current limiting device being actuatable from an exterior of the serviceable unit;

FIG. 3A illustrates a representative view of the exemplary serviceable unit and current limiting device of FIG. 3;

FIG. 4 illustrates an exemplary serviceable unit and an exemplary current limiting device adapted to be coupled in an electrical connection between two series battery units of the serviceable unit;

FIG. 4A illustrates a representative view of the exemplary serviceable unit and current limiting device of FIG. 4;

FIG. 5 illustrates an exemplary embodiment of the current limiting device of FIG. 2;

FIG. 6 illustrates the current limiting device of FIG. 5 coupled to a terminal connection of an exemplary serviceable unit;

FIG. 7 is a sectional view along lines 7-7 in FIG. 6;

FIG. 8 illustrates a top view of a main body member of the current limiting device of FIG. 5;

FIG. 9 is a sectional view along lines 9-9 in FIG. 8;

FIG. 10 is a sectional view along lines 10-10 in FIG. 8;

FIG. 11 is a sectional view along lines 11-11 in FIG. 8;

FIG. 12 illustrates an exemplary embodiment of the current limiting device of FIG. 4;

FIG. 12A illustrates an exemplary installation site for the current limiting device of FIG. 12;

FIG. 13 is a sectional view along lines 13-13 in FIG. 12;

FIG. 14 illustrates an exploded assembly view of an exemplary embodiment of the current limiting device of FIG. 3;

FIG. 15 illustrates a perspective, assembled view of the current limiting device of FIG. 14;

FIG. 16 illustrates the current limiting device of FIG. 14 assembled to an exterior wall of the serviceable unit and positioned in a shipping configuration;

FIG. 17 illustrates the current limiting device of FIG. 14 assembled to an exterior wall of the serviceable unit and positioned in an operation configuration;

FIG. 18 illustrates a portion of the exterior wall of the serviceable unit adapted to couple the current limiting device of FIG. 15; and

FIG. 19 illustrates an exemplary embodiment of the current limiting device of FIG. 2;

FIG. 20 illustrates a bottom view of the current limiting device of FIG. 19; and

FIG. 21 is an exemplary sequence of use of the disclosed current limiting devices.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplification set out herein illustrates embodiments of the invention, and such exemplifications are not to be construed as limiting the scope of the invention in any manner.

### DETAILED DESCRIPTION OF THE DRAWINGS

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrated devices and described methods and further applications of the principles of the invention which would normally occur to one skilled in the art to which the invention relates.

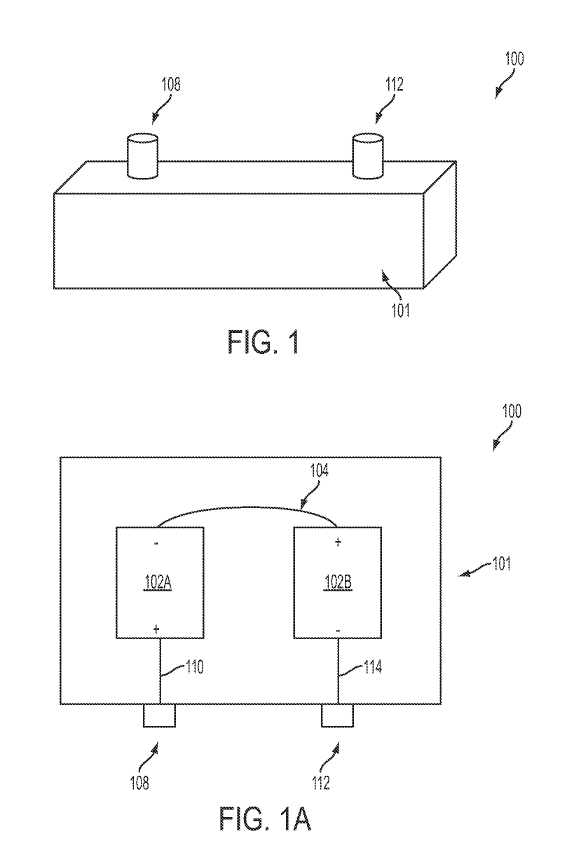

As used herein, the term “serviceable unit” is defined to mean a device including a positive electrical terminal connection, a negative electrical terminal connection and a plurality of energy storage devices electrically coupled to the positive electrical terminal connection and the negative electrical terminal connection. Referring to FIGS. 1 and 1A, an exemplary serviceable unit 100 is shown. Serviceable unit 100 includes a housing 101 which supports a plurality of energy storage units 102, illustratively energy storage unit 102A and 102B are shown. Exemplary energy storage units include batteries. Exemplary batteries include lithium ion batteries. Exemplary energy storage units include prismatic battery cells. Exemplary serviceable units 100 are disclosed in PCT Published Application No. WO2012/167269, application number PCT/US2012/040776, filed Jun. 4, 2012, titled ENERGY STORAGE SYSTEM and in PCT Published Application No. WO2012/158185, application number PCT/US2011/052169, filed Sep. 19, 2011, titled ENERGY STORAGE SYSTEM, the disclosures of which are expressly incorporated by reference herein.

In one embodiment, a fully charged open circuit voltage of the serviceable unit is about 192 volts (“V”). In one embodiment, a fully charged open circuit voltage of the serviceable unit is about 48 V. In one embodiment, a fully charged open circuit voltage of the serviceable unit is about 96 V. In one embodiment, a fully charged open circuit voltage of the serviceable unit is between about 12 V and about 192 V. In one embodiment, a fully charged open circuit voltage of the serviceable unit is between about 24 V and about 192 V. In one embodiment, a fully charged open circuit voltage of the serviceable unit is between about 48 V and about 192 V. In one embodiment, a fully charged open circuit voltage of the serviceable unit is between about 12 V and about 96 V. In one embodiment, a fully charged open circuit voltage of the serviceable unit is between about 12 V and about 48 V. In one embodiment, a fully charged open circuit voltage of the serviceable unit is between about 24 V and about 48 V. In one embodiment, the serviceable units disclosed in PCT Published Application No. WO2012/167269, application number PCT/US2012/040776, filed Jun. 4, 2012, titled ENERGY STORAGE SYSTEM and in PCT Published Application No. WO2012/158185, application number PCT/US2011/052169, filed Sep. 19, 2011, titled ENERGY STORAGE SYSTEM provide fully charged open circuit voltages in these ranges.

Although two energy storage units 102 are illustrated, serviceable unit 100 may include any number of energy storage units. Further, the illustrated energy storage units are shown electrically connected in series through connection 104. The energy storage units of serviceable unit 100 may be electrically coupled together in series, in parallel, and in combinations of series and parallel.

Serviceable unit 100 includes a positive electrical terminal connection 108 electrically coupled to the energy storage units 102 through connection 110 and a negative electrical terminal connection 112 electrically coupled to the energy storage units 102 through connection 114.

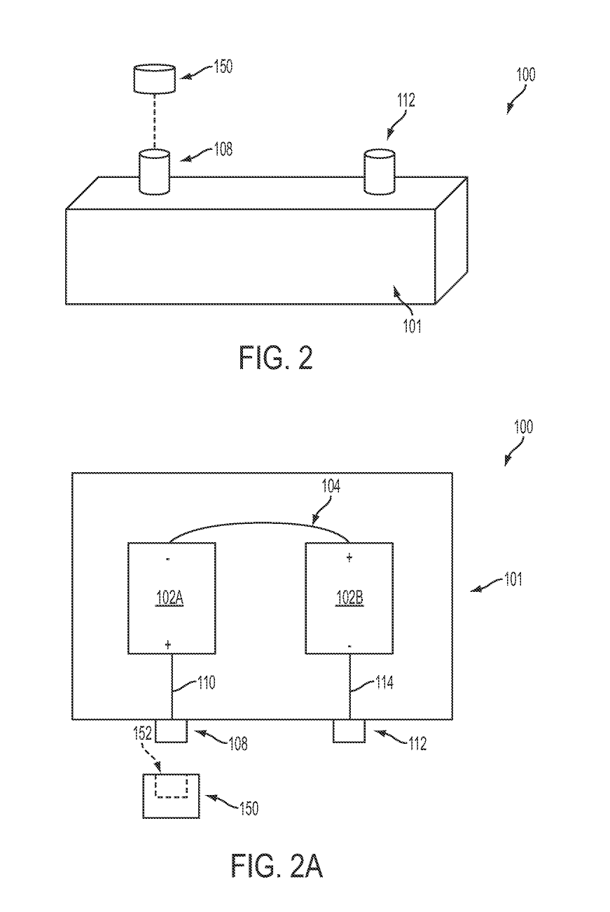

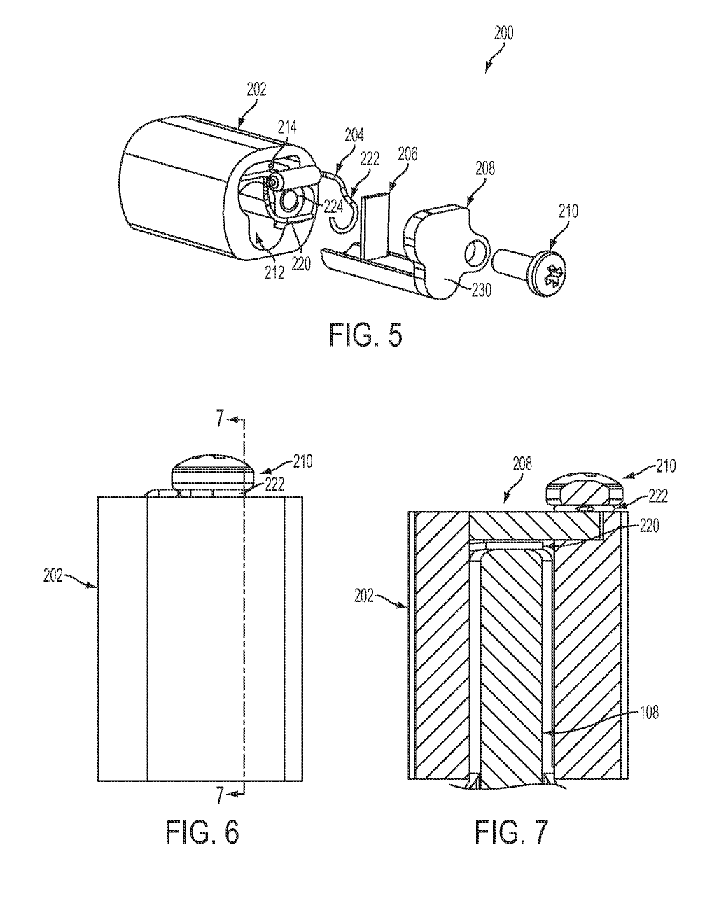

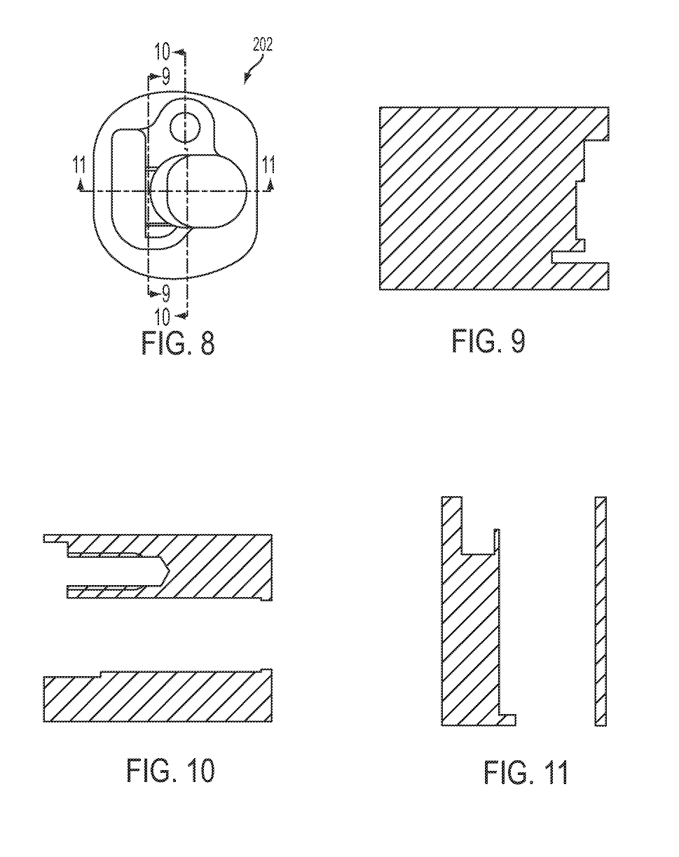

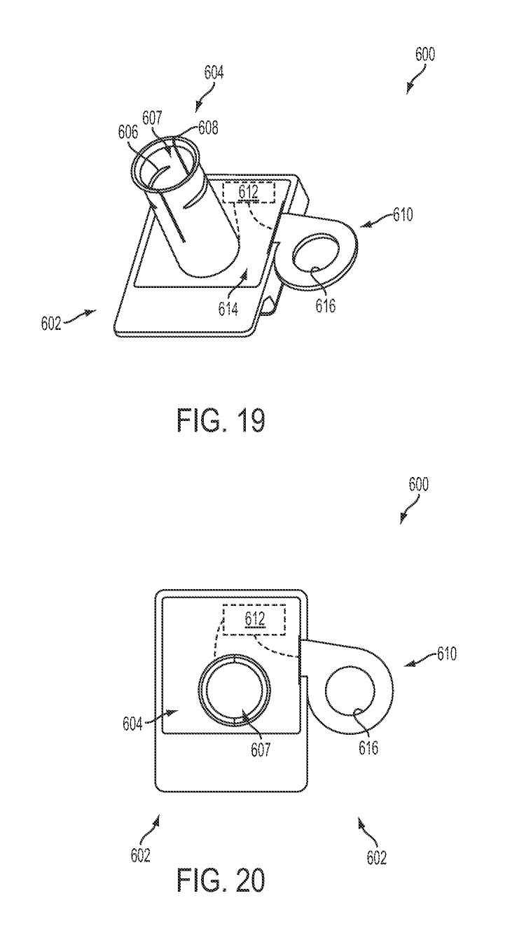

Referring to FIGS. 2 and 2A, an exemplary current limiting device 150 is illustrated. Current limiting device 150 includes a recess 152 which receives positive electrical terminal connection 108 of serviceable unit 100. Current limiting device 150 includes at least one current limiting component which limits the amount of current that may inrush into energy storage units 102. Exemplary current limiting components include resistors, fuses, and other suitable devices for limiting the current through the electrical path of positive electrical terminal connection 108, the energy storage devices 102, and negative electrical terminal connection 112. An exemplary embodiment of current limiting device 150 is illustrated and described herein in connection with FIGS. 5-11. Another exemplary embodiment of current limiting device 150 is illustrated and described herein in connection with FIGS. 19 and 20.

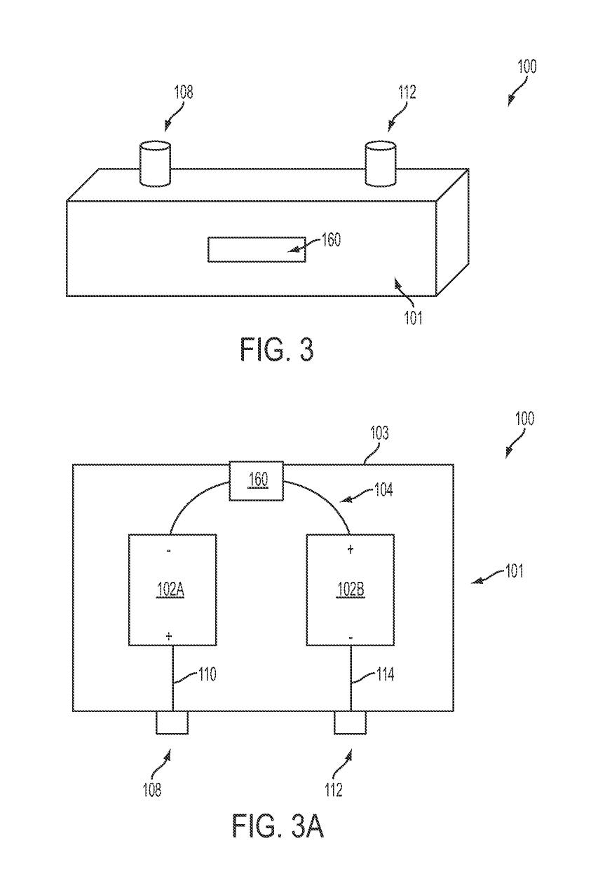

Referring to FIGS. 3 and 3A, an exemplary current limiting device 160 is illustrated. Current limiting device 160 is provided in the electrical connection 104 between energy storage device 102A and energy storage device 102B. Current limiting device 160 includes at least one current limiting component which is included in electrical connection 104 to limit the amount of current that may inrush into energy storage units 102. Exemplary current limiting components include resistors, fuses, and other suitable devices for limiting the current through the electrical path of positive electrical terminal connection 108, the energy storage devices 102, and negative electrical terminal connection 112. Although current limiting device 160 is illustrated as being provided in the electrical connection 104, alternatively it may be provided in electrical connection 110 or in electrical connection 114.

In the illustrated embodiment, current limiting device 160 extends out from a wall 103 of housing 101 and is actuatable by an operator. The operator may manipulate current limiting device 160 to a first configuration wherein the current limiting component is included in the electrical connection 104 to limit the amount of current and a second configuration wherein the current limiting component is not included in the electrical connection 1-4 and current is still able to flow between energy storage device 102A and energy storage device 102B. An exemplary embodiment of current limiting device 160 is illustrated and described herein in connection with FIGS. 14-18.

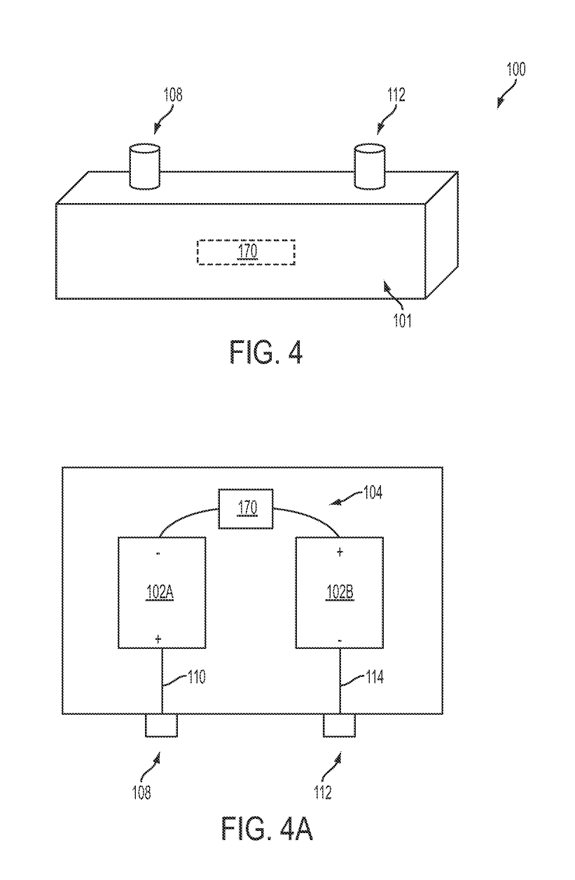

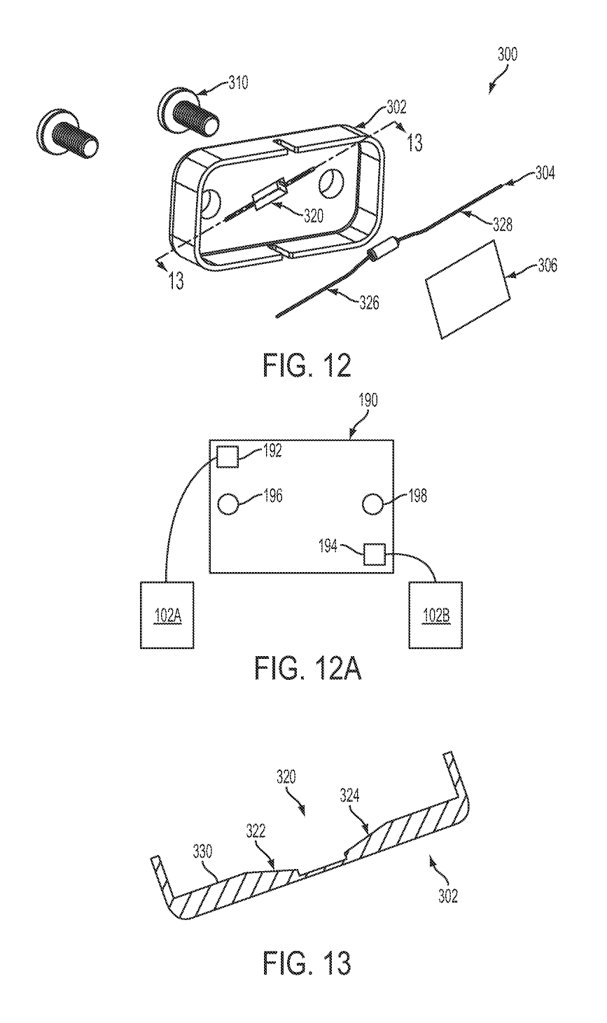

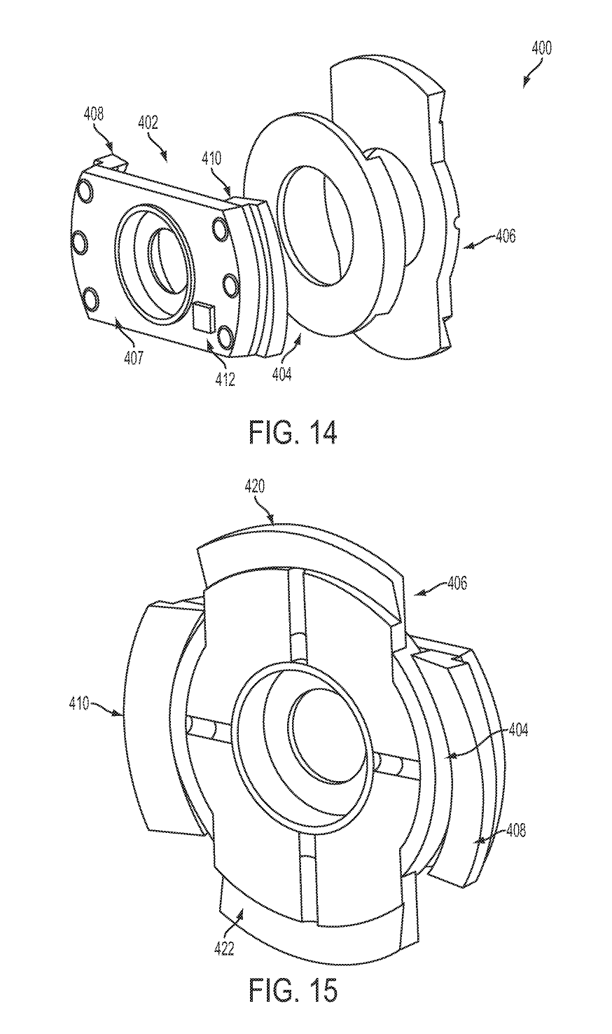

Referring to FIGS. 4 and 4A, an exemplary current limiting device 170 is illustrated. Current limiting device 170 is provided in the electrical connection 104 between energy storage device 102A and energy storage device 102B. Current limiting device 170 includes at least one current limiting component which is included in electrical connection 104 to limit the amount of current that may inrush into energy storage units 102. Exemplary current limiting components include resistors, fuses, and other suitable devices for limiting the current through the electrical path of positive electrical terminal connection 108, the energy storage devices 102, and negative electrical terminal connection 112. Although current limiting device 170 is illustrated as being provided in the electrical connection 104, alternatively it may be provided in electrical connection 110 or in electrical connection 114. An exemplary embodiment of current limiting device 170 is illustrated and described herein in connection with FIGS. 12 and 13.

In one embodiment, a 0.25 W current limiting component is to be used for current limiting device 150, current limiting device 160, and current limiting device 170. A first exemplary current limiting component is a 20 kilo-ohm, 0.25 W resistor. A second exemplary current limiting component is a PICO II brand form factor, fast 1 A, 125V axial fuse (part no. 0251001.MXL available from Little Fuse).

In one embodiment, wherein the current limiting component is a resistor, the resistance value is determined based on equation 1:

$$W = \frac{{V}^{2}}{R} \qquad ( 1 )$$

wherein W is the derated power value of the component in Watts (for a 0.25 W resistor, a derated value of 50% is used in one example), V is the voltage of the serviceable unit in Volts, and R is the resistance of the current limiting component in ohms. As an example, with a derated power of 0.125 W and a voltage of 100V, the resistance value should be about 80 kilo-ohms.

Referring to FIG. 5, an exemplary current limiting device 200 is shown. Current limiting device 200 includes a cover 202, a current limiting component 204, a foam adhesive component 206, a terminal lock component 208, and a retainer 210. Cover 202 includes a cavity 212 which receives positive electrical terminal connection 108 (see FIG. 7) and terminal lock component 208. Terminal lock component 208 causes current limiting device 200 to be coupled to positive electrical terminal connection 108 through a friction fit. Other methods of coupling current limiting device 200 to positive electrical terminal connection 108 may be used.

Cover 202 includes a recess 214 which receives current limiting component 204. Foam adhesive component 206 generally maintains the position of current limiting component 204 in recess 214. In one embodiment, current limiting device 200 is assembled as follows. Current limiting component 204 is placed in recess 214. Foam adhesive component 206 and terminal lock component 208 are received in cavity 212. Retainer 210 (illustratively a screw) is threaded into a threaded opening 224 of cover 202.

Current limiting device 200 is then press fit onto positive electrical terminal connection 108. As shown in FIG. 7, a first lead wire 220 of current limiting component 204 is held in contact with positive electrical terminal connection 108. A second lead wire 222 of current limiting component 204 is held in contact with retainer 210. As such, retainer 210 is electrically coupled to positive electrical terminal connection 108. An operator may cause a short circuit of serviceable unit 100 by placing an electrical conductor on negative electrical terminal connection 112 and on retainer 210. The current limiting component 204 will limit the inrush of current to energy storage devices 102 due to the short circuit. In the case of a fuse, the fuse will blow creating an open circuit once a current threshold of the fuse is reached. Once the fuse blows, the voltage difference between positive electrical terminal connection 108 and negative electrical terminal connection 112 cannot be measured until current limiting device 200 removed. In the case of a resistor, the resistor limits the amount of current that will flow through energy storage devices 102. The use of the resistor permits the voltage difference between positive electrical terminal connection 108 and negative electrical terminal connection 112 to continue to be measured. However, if the short circuit condition is allowed to continue, over time the voltage of the energy storage units 102 will be drained to about 0 volts.

In one embodiment, terminal lock component 208 is made from an electrically conductive material having a known resistance. In this embodiment, a separate current limiting component 204 is not needed. Rather, terminal lock component 208 forms the contact with positive electrical terminal connection 108 and provides a contact surface 230. An operator may cause a short circuit of serviceable unit 100 by placing an electrical conductor on negative electrical terminal connection 112 and on contact surface 230 of terminal lock component 208.

Referring to FIGS. 19 and 20, an exemplary current limiting device 600 is shown. Current limiting device 600 includes a base or cover 602, a terminal connector 604, a terminal 610, and a current limiting component 612. Terminal connector 604 is electrically coupled to one side of current limiting component 612 and terminal 610 is electrically coupled to another side of the current limiting component 612 resulting in the current limiting component 612 being in the electrical path between the terminal connector 604 and terminal 610.

Terminal connector 604, current limiting component 612, and terminal 610 are assembled and are received in a pocket in base 602. The pocket is filled with an epoxy potting material 614 to secure the components. Terminal connector 604 includes a cavity 607 which receives positive electrical terminal connection 108 or negative terminal connection 112. Terminal connector 604 further includes a plurality of slots 608 which permit the end of terminal connector 604 to expand as the respective one of the positive electrical terminal connection 108 or negative terminal connection 112 is received. Further, the walls of the terminal connector 604 include rib features 606 which extend inward and grip the respective one of the positive electrical terminal connection 108 or negative terminal connection 112 when received in cavity 607. As such, terminal connector 604 causes current limiting device 600 to be coupled to the respective one of positive electrical terminal connection 108 and negative terminal connection 112 through a friction fit. Other methods of coupling current limiting device 600 to the respective one of positive electrical terminal connection 108 and negative terminal connection 112 may be used.

Terminal 610 extends from a side of base 602. Terminal 610 is illustratively shown as a lug, but may be a stud or other suitable shapes. Terminal 610 includes an aperture 616.

In operation, current limiting device 600 is press fit onto positive electrical terminal connection 108 placing terminal 610 in electrical connection with positive electrical terminal connection 108. An operator may cause a short circuit of serviceable unit 100 by placing an electrical conductor on negative electrical terminal connection 112 and on terminal 610. The current limiting component 204 will limit the inrush of current to energy storage devices 102 due to the short circuit. In the case of a fuse, the fuse will blow creating an open circuit once a current threshold of the fuse is reached. Once the fuse blows, the voltage difference between positive electrical terminal connection 108 and negative electrical terminal connection 112 cannot be measured until current limiting device 200 removed. In the case of a resistor, the resistor limits the amount of current that will flow through energy storage devices 102. The use of the resistor permits the voltage difference between positive electrical terminal connection 108 and negative electrical terminal connection 112 to continue to be measured. However, if the short circuit condition is allowed to continue, over time the voltage of the energy storage units 102 will be drained to about 0 volts.

Referring to FIG. 12, an exemplary current limiting device 300 is shown. Current limiting device 300 includes a cover 302, a current limiting component 304, an adhesive component 306, and a pair of retainers 310. Cover 302 includes a pocket 320 which receives current limiting component 304. Adhesive component 306 holds current limiting component 304 in pocket 320. Ramp surfaces 322 and 324 lead into pocket 320 and retain lead wires 326 and 328, respectively. The ramp surfaces 322 and 324 result in lead wires 326 and 328 extending above surface 330 of cover 302.

Referring to FIG. 12A, an exemplary installation for current limiting device 300 is shown. Prior to installation, current limiting component 304 is received in pocket 320 and adhesive component 306 secures current limiting component 304 in place. The ends of lead wires 326 and 328 are trimmed to the appropriate lengths.

Referring to FIG. 12A, a circuit board 190 of serviceable unit 100 is shown. Circuit board 190 includes a contact pad 192 and a contact pad 194. Contact pad 192 is positioned to generally make contact with lead wire 326 of current limiting component 304. Contact pad 194 is positioned to make contact with lead wire 328 of current limiting device 300. Retainers 310 are then threaded into threaded openings 196 and 198 to secure current limiting device 300 in place.

At this point, energy storage unit 102A is electrically coupled to energy storage unit 102B. An operator may cause a short circuit of serviceable unit 100 by placing an electrical conductor on negative electrical terminal connection 112 and on negative electrical terminal connection 112. The current limiting component 304 will limit the inrush of current to energy storage devices 102 due to the short circuit. In the case of a fuse, the fuse will blow creating an open circuit once a current threshold of the fuse is reached. Once the fuse blows, the voltage difference between positive electrical terminal connection 108 and negative electrical terminal connection 112 cannot be measured until current limiting device 300 removed and replaced with an electrical conductor. In the case of a resistor, the resistor limits the amount of current that will flow through energy storage devices 102. The use of the resistor permits the voltage difference between positive electrical terminal connection 108 and negative electrical terminal connection 112 to continue to be measured. However, if the short circuit condition is allowed to continue, over time the voltage of the energy storage units 102 will be drained to about 0 volts.

Referring to FIG. 14, an exemplary current limiting device 400 is shown. Current limiting device 400 includes a carrier 402, an insulator 404, and a buss bar 406. Carrier 402 includes a body 407 having coupled thereto a first copper pad 408 and a second copper pad 410. The first copper pad 408 and the second copper pad 410 are electrically coupled together through a current limiting component 412 carried by body 407.

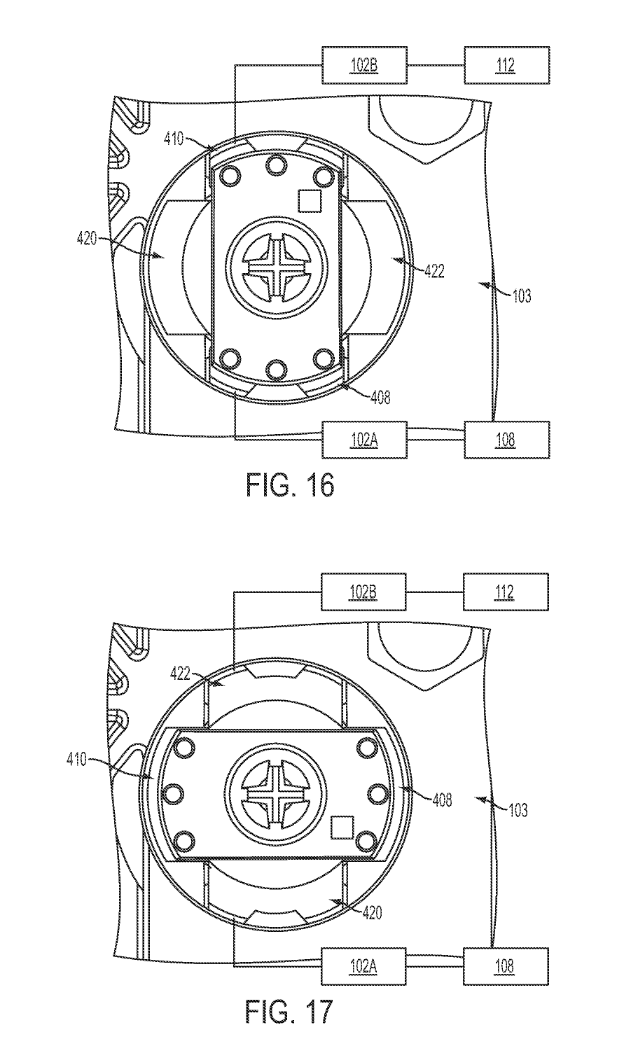

Referring to FIG. 15, buss bar 406 includes a first end 420 and a second end 422. When carrier 402, insulator 404, and buss bar 406 are assembled together, first end 420, second end 422, buss bar 406, and first copper pad 408 all generally have the same radial extent. As such, current limiting device 400 may be coupled to wall 103 in a recess 176 of wall 103. Wall 103 may include electrical contacts positioned generally 180 degrees apart relative to a central axis of the recess. By rotating current limiting device 400 relative to wall 103 cover 302, either first end 420 and second end 422 may be placed in electrical communication with energy storage device 102A and energy storage device 102B (see FIG. 17) or buss bar 406 and first copper pad 408 may be placed in electrical communication with energy storage device 102A and energy storage device 102B (see FIG. 16).

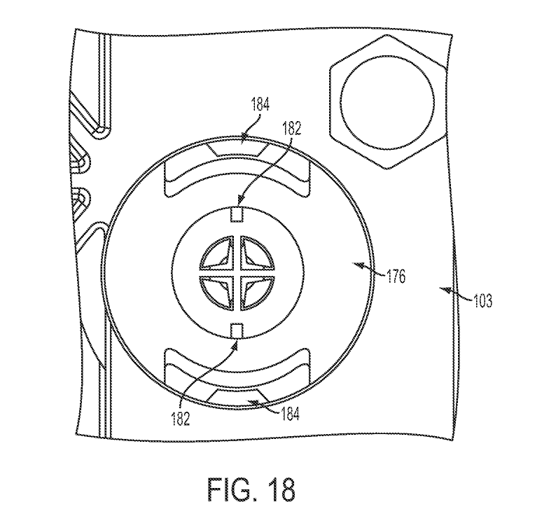

Referring to FIG. 18, recess 176 may include tabs 184 to press the respective electrical contacts of current limiting device 400 into contact with the electrical contacts of serviceable unit 100. Further, recess 176 may include detents 182 which lock current limiting device 400 in either the orientation shown in FIG. 16 or the orientation shown in FIG. 17.

Since in the orientation shown in FIG. 16, current limiting component 412 is in electrical communication with energy storage devices 102A and 102B, current limiting component 412 limits the amount of current during a short circuit condition. This configuration is referred to as a shipping configuration. In the orientation shown in FIG. 17, current limiting component 412 is not in electrical communication with energy storage devices 102A and 102B, current limiting component 412 does not limit the amount of current. Rather, the current flows through buss bar 406. This configuration is referred to as a use configuration.

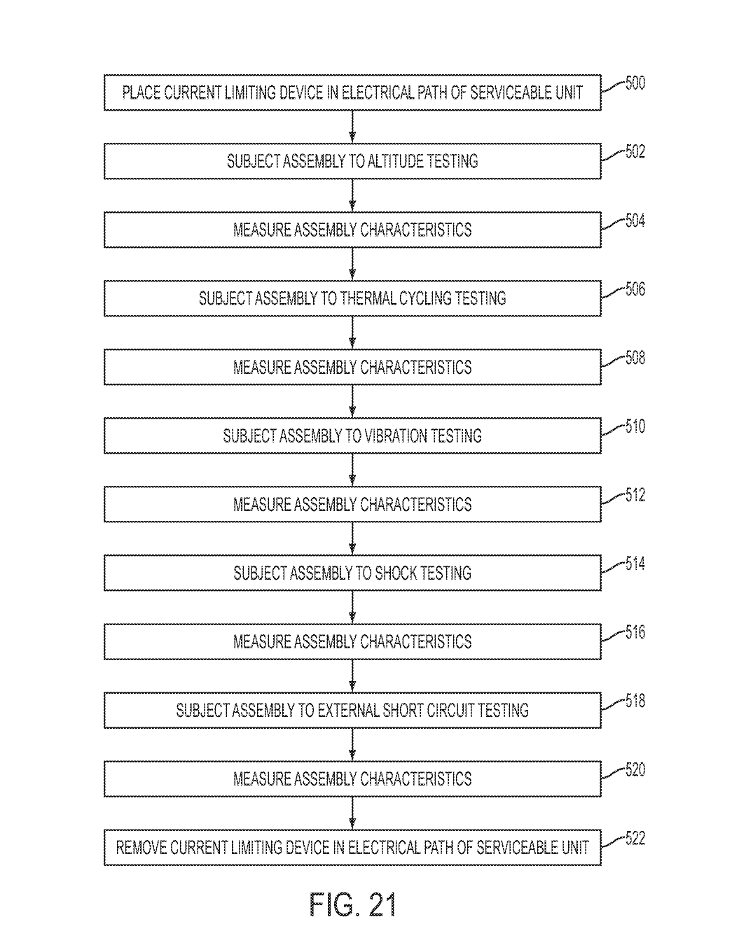

Referring to FIG. 21, an exemplary method of use of the current limiting devices disclosed herein is shown. The current limiting device is placed in the electrical path of the serviceable unit, as represented by block 500. In the case of current limiting device 200, current limiting device 200 is assembled to either positive electrical terminal connection 108 or negative electrical terminal connection 112. In the case of current limiting device 300, current limiting device 300 replaces an electrical conductor and contacts contact pads 192 and 194. In the case of current limiting device 400, current limiting device 400 is turned to the orientation shown in FIG. 16.

The assembly of serviceable unit 100 and the respective current limiting device is subjected to altitude testing, as represented by block 502. An exemplary altitude test is that the assembly of serviceable unit 100 and the respective current limiting device are stored for a minimum of 6 hours at a pressure of 11.6 kPa and a temperature of 20° C. After the altitude test is complete, characteristics of the assembly are measured, as represented by block 504 In one embodiment, the assembly passes the altitude test if no mass loss is recorded, a post test voltage between positive electrical terminal connection 108 and negative electrical terminal connection 112 is not less than 90% of a pre test voltage between positive electrical terminal connection 108 and negative electrical terminal connection 112 and a thermal event has not occurred. Exemplary thermal events include disassembly, rupture, or fire.

The assembly of serviceable unit 100 and the respective current limiting device is subjected to thermal cycling testing, as represented by block 506. An exemplary thermal cycling test is that the assembly of serviceable unit 100 and the respective current limiting device are stored for a minimum of 6 hours at +75° C. followed by 6 hours at −40° C. with a 30 minute transition between temperature extremes. This cycle is repeated 10 times. After the thermal cycling test is complete, characteristics of the assembly are measured, as represented by block 508. In one embodiment, the assembly passes the thermal cycling test if no mass loss is recorded, a post test voltage between positive electrical terminal connection 108 and negative electrical terminal connection 112 is not less than 90% of a pre test voltage between positive electrical terminal connection 108 and negative electrical terminal connection 112 and a thermal event has not occurred. Exemplary thermal events include disassembly, rupture, or fire.

The assembly of serviceable unit 100 and the respective current limiting device is subjected to vibration testing, as represented by block 510. An exemplary vibration test is that the assembly of serviceable unit 100 and the respective current limiting device are mounted in a vibration test fixture and vibrated according to a logarithmic sweep between 7 Hz and 200 Hz and back to 7 Hz in 15 minutes. This cycle is repeated 12 times for a total of 3 hours for each of 3 mutually perpendicular mounting positions. Peak acceleration is 8 gn. After the vibration test is complete, characteristics of the assembly are measured, as represented by block 512. In one embodiment, the assembly passes the vibration test if no mass loss is recorded, a post test voltage between positive electrical terminal connection 108 and negative electrical terminal connection 112 is not less than 90% of a pre test voltage between positive electrical terminal connection 108 and negative electrical terminal connection 112 and a thermal event has not occurred. Exemplary thermal events include disassembly, rupture, or fire.

The assembly of serviceable unit 100 and the respective current limiting device is subjected to shock testing, as represented by block 514. An exemplary shock test is that the assembly of serviceable unit 100 and the respective current limiting device are mounted in a shock test fixture and experience three shocks per direction (positive and negative) in each axis, for a total of 18 shocks. (cell level: 150 g for 6 ms, pack level (multiple cells housed together) 50 g for 6 ms) After the shock test is complete, characteristics of the assembly are measured, as represented by block 516. In one embodiment, the assembly passes the shock test if no mass loss is recorded, a post test voltage between positive electrical terminal connection 108 and negative electrical terminal connection 112 is not less than 90% of a pre test voltage between positive electrical terminal connection 108 and negative electrical terminal connection 112 and a thermal event has not occurred. Exemplary thermal events include disassembly, rupture, or fire.

The assembly of serviceable unit 100 and the respective current limiting device is subjected to short circuit testing, as represented by block 518. An exemplary short circuit test is that the assembly of serviceable unit 100 and the respective current limiting device are conditioned at 55° C. is subjected to a short circuit condition with an external circuit resistance of less than 0.1 ohm for at least one hour after the external case temperature has returned to 55° C. Observation continues for six hours. After the short circuit test is complete, characteristics of the assembly are measured, as represented by block 520. In one embodiment, the assembly passes the short circuit test if a temperature of the exterior of the assembly remains less than 170 degrees C. and a thermal event has not occurred. Exemplary thermal events include disassembly, rupture, or fire.

Once testing is complete, the current limiting device is removed from the electrical path of the serviceable unit, as represented by block 522. In the case of current limiting device 200, current limiting device 200 is disassembled from either positive electrical terminal connection 108 or negative electrical terminal connection 112. In the case of current limiting device 300, current limiting device 300 is removed and replaced with an electrical conductor which contacts contact pads 192 and 194. In the case of current limiting device 400, current limiting device 400 is turned to the orientation shown in FIG. 17.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. An assembly, comprising
a serviceable unit including a positive electrical terminal connection, a negative electrical terminal connection, and a plurality of energy storage devices operatively coupled to the positive electrical terminal connection and the negative electrical terminal connection to form an electrical path of the serviceable unit; and
a current limiting device coupled to the serviceable unit and including a current limiting component, the current limiting component being included in the electrical path of the serviceable unit.

2. The assembly of claim 1, wherein the current limiting component is selected from the group of a resistor and a fuse.

3. The assembly of claim 1, wherein the current limiting device is removably coupled to one of the positive electrical terminal connection and the negative electrical terminal connection.

4. The assembly of claim 3, wherein the current limiting component is selected from the group of a resistor and a fuse.

5. The assembly of claim 3, wherein the plurality of energy storage devices includes a plurality of prismatic cells electrically coupled together, the plurality of electrical storage devices having a fully charged open circuit voltage of between about 12 volts and about 192 volts.

6. The assembly of claim 3, wherein the plurality of energy storage devices includes a plurality of prismatic cells electrically coupled together, the plurality of electrical storage devices having a fully charged open circuit voltage of between about 24 volts and about 48 volts.

7. The assembly of claim 3, wherein the current limiting device is press fit onto one of the positive electrical terminal connection and the negative electrical terminal connection.

8. The assembly of claim 3, wherein the current limiting device provides a terminal that is electrically connected to the one of the positive electrical terminal connection and the negative electrical terminal connection that the current limiting device is coupled to through the current limiting component.

9. The assembly of claim 8, wherein the current limiting device includes a terminal connector having a cavity which receives the one of the positive electrical terminal connection and the negative electrical terminal connection and a base which is coupled to the terminal connector and the current limiting component.

10. The assembly of claim 9, wherein the terminal is supported by the base.

11. The assembly of claim 1, wherein the current limiting device is coupled to the serviceable unit in place of an electrical component of the electrical path.

12. The assembly of claim 11, wherein the current limiting component is selected from the group of a resistor and a fuse.

13. The assembly of claim 11, wherein the plurality of energy storage devices includes a plurality of prismatic cells electrically coupled together, the plurality of electrical storage devices having a fully charged open circuit voltage of between about 12 volts and about 192 volts.

14. The assembly of claim 11, wherein the plurality of energy storage devices includes a plurality of prismatic cells electrically coupled together, the plurality of electrical storage devices having a fully charged open circuit voltage of between about 24 volts and about 48 volts.

15. The assembly of claim 1, wherein the current limiting device is positioned in a first configuration relative to the serviceable unit to place the current limiting component in the electrical path and in a second configuration relative to the serviceable unit to remove the current limiting component from the electrical path.

16. The assembly of claim 15, wherein the current limiting device includes a carrier which supports current limiting component, the carrier being moveable relative to a housing of the serviceable unit, the carrier being in a first position relative to the housing in the first configuration and in a second position relative to the housing in the second configuration.

17. The assembly of claim 15, wherein the current limiting component is selected from the group of a resistor and a fuse.

18. The assembly of claim 15, wherein the plurality of energy storage devices includes a plurality of prismatic cells electrically coupled together, the plurality of electrical storage devices having a fully charged open circuit voltage of between about 12 volts and about 192 volts.

19. The assembly of claim 15, wherein the plurality of energy storage devices includes a plurality of prismatic cells electrically coupled together, the plurality of electrical storage devices having a fully charged open circuit voltage of between about 24 volts and about 48 volts.

20. A method of testing a serviceable unit including a positive electrical terminal connection, a negative electrical terminal connection, and a plurality of energy storage devices operatively coupled to the positive electrical terminal connection and the negative electrical terminal connection to form an electrical path of the serviceable unit, the method comprising the steps of sequentially:
(a) placing a current limiting device in the electrical path of the serviceable unit, the current limiting device including a current limiting component;
(b) subjecting the serviceable unit with the current limiting device to a vibration testing;
(c) measuring a voltage of the serviceable unit, the voltage generally corresponding to the voltage difference between the positive electrical terminal connection and the negative electrical terminal connection;
(d) shorting the positive electrical terminal connection to the negative electrical terminal connection; and
(e) removing the current limiting device from the electrical path of the serviceable unit.

21. The method of claim 20, wherein the step of placing the current limiting device in the electrical path of the serviceable unit includes the step of coupling the current limiting device to one of the positive terminal electrical connection and the negative terminal electrical connection, the current limiting device providing a terminal, the current limiting component being in an electrical path between the one of the positive terminal electrical connection and the negative terminal electrical connection and the terminal.

22. The method of claim 21, wherein the step of measuring a voltage of the serviceable unit, the voltage generally corresponding to the voltage difference between the positive electrical terminal connection and the negative electrical terminal connection is performed by measuring a voltage between the terminal of the current limiting device and the other of the positive electrical terminal connection and the negative electrical terminal connection.

23. The method of claim 21, wherein the step of shorting the positive electrical terminal connection to the negative electrical terminal connection includes the step of establishing an external electrical connection between the terminal of the current limiting device and the other of the positive electrical terminal connection and the negative electrical terminal connection.

24. The method of claim 23, wherein the external electrical connection between the terminal of the current limiting device and the other of the positive electrical terminal connection and the negative electrical terminal connection includes a circuit resistance of less than 0.1 ohms.

25. The method of claim 23, further comprising the steps of:
maintaining the external electrical connection for at least one hour; and
monitoring an external temperature of the serviceable unit.

26. The method of claim 21, wherein the step of coupling the current limiting device to one of the positive terminal electrical connection and the negative terminal electrical connection includes the step of receiving the one of the positive terminal electrical connection and the negative terminal electrical connection within a cavity of the current limiting device.

27. The method of claim 20, wherein the step of placing the current limiting device in the electrical path of the serviceable unit includes the step of replacing an electrical conductor of the serviceable unit with the current limiting device.

28. The method of claim 20, wherein the electrical conductor of the serviceable unit and the current limiting device are supported by a carrier and the step of replacing the electrical conductor of the serviceable unit with the current limiting device includes the step of rotating the carrier which removes the electrical conductor of the serviceable unit from the electrical path of the serviceable unit and includes the current limiting device in the electrical path of the serviceable unit.

29. The method of claim 23, wherein at least one of the following steps are performed in any order between step (a) and step (d):
subjecting the serviceable unit with the current limiting device to an altitude testing;
subjecting the serviceable unit with the current limiting device to a thermal cycling testing; and
subjecting the serviceable unit with the current limiting device to a shock testing.

30. The method of claim 23, wherein at least two of the following steps are performed in any order between step (a) and step (d):
subjecting the serviceable unit with the current limiting device to an altitude testing;
subjecting the serviceable unit with the current limiting device to a thermal cycling testing; and
subjecting the serviceable unit with the current limiting device to a shock testing.

31. The method of claim 23, wherein at least all of the following steps are performed in any order between step (a) and step (d):
subjecting the serviceable unit with the current limiting device to an altitude testing;
subjecting the serviceable unit with the current limiting device to a thermal cycling testing; and
subjecting the serviceable unit with the current limiting device to a shock testing.
